(19) United States
(12) Patent Application Publication
(10) Pub. No.: US 2009/0250021 A1
(43) Pub. Date: Oct. 8, 2009

(54) FLUID CONTROL SYSTEMS EMPLOYING COMPLIANT ELECTROACTIVE MATERIALS

(75) Inventors: Alireza ZARRABI, Santa Clara, CA (US); Ilya POLYAKOV, San Francisco, CA (US); Jonathan R. HEIM, Pacifica, CA (US)

Correspondence Address: LEVINE BAGADE HAN LLP, 2400 GENG ROAD, SUITE 120, PALO ALTO, CA, 94303, US

(73) Assignee: Artificial Muscle, Inc., Sunnyvale, CA (US)

(21) Appl. No.: 12/244,695

(22) Filed: Oct. 2, 2008

Related U.S. Application Data
(60) Provisional application No. 60/977,081, filed on Oct. 2, 2007.

(51) Int. Cl. F01L 9/04; F16K 31/02

(52) U.S. Cl. 123/90.11; 251/129.06; 137/596.16; 137/625.64

(57) ABSTRACT

The present invention includes fluid control systems employing compliant electroactive materials.

### FIELD OF THE INVENTION

The present invention relates to fluid control systems employing compliant electroactive materials. In particular, it relates to valves constructed of transducers made of compliant electroactive materials.

### BACKGROUND

There are many types of conventional valve systems where flow through the valve is controlled by a valve actuator, such as a solenoid actuator, piezoelectric actuators, stepper actuators, etc.

With solenoid-controlled valves, a plunger made of magnetic material is slidable within a solenoid coil, and a spring or other biasing means urges the plunger into contact with a valve seat or seal, or visa-versa. When no current is supplied to the solenoid, the valve is maintained closed by the spring if a normally-closed valve, and open if a normally-open valve. When current flows in the solenoid, a magnetic force acts against the spring to move the plunger, the end of which is often referred to as a poppet or orifice, away from or towards the valve seat, depending on the valve's normal position when the solenoid is in its off state. When the magnetic force exceeds the force of the spring, the poppet is moved out of (or into) contact with the valve seat to a remote (or adjacent) position in which the valve is fully open (or fully closed). Such a valve (whether normally closed or normally open) has essentially only two states, open and closed.

A proportional valve is one in which the plunger/poppet moves relative to the valve seat in a controlled manner whereby the flow rate through the valve varies in proportion to the current supplied to the solenoid. Such a valve is desirable for many applications in which a gradual or graded variation in flow is preferable to discrete on and off states where the transition between the on and off states is immediate.

Because many valve applications involve the passage of fluid from a chamber or source having an overall greater volume to one having a lesser volume, the pressure on the inlet or upstream side of a valve is typically greater than on its outlet or downstream side. As a result, the work (force x stroke) required of the actuator to maintain the valve in the open or closed position (depending on the valves bias, i.e., naturally open or naturally closed) is necessarily greater than the amount of work that would be required in a balanced environment, i.e., where the fluid pressure on the inlet and outlet sides is substantially equal. Furthermore, in the context of a proportional valve, this unbalanced condition affects the ability to precisely control the opening and closing of the valve seat.

Another consideration in determining valve design is the need in most cases to prevent the fluid medium, particularly liquids, from contacting the conductive and mechanical portions of the actuator and valve mechanisms to ensure proper performance of the valve and to prevent corrosion and shorting of the electrical/electronic based components of the actuator and valve. This also serves to prevent contamination of the fluid by the valve and actuator components, such as in medical applications. Providing this so-called “non-wetted” environment typically involves positioning these components more remotely from the remaining valve armature or, alternatively, isolating them with a protective barrier. Because of the extra force created by the added distance and/or the barrier, such non-wetted valve systems are relatively less efficient. See, e.g., U.S. Pat. No. 5,375,738 which discloses a non-wetted solenoid valve.

The advent of dielectric elastomer materials, also referred to as “electroactive polymers” (EAPs), has provided significant advancement in many transducer-based technologies. U.S. Pat. Nos. 7,394,282, 7,362,032, 7,320,457, 7,259,503, 7,064,472, and 7,052,594 and U.S. Published Patent Application Nos. 2007/0200457, 2007/0200468, and 2006/0208610 disclose various EAP transducer configurations for use in valves and other fluid control mechanisms. The size, weight, power, heat generation, controllability, environmental and cost benefits and advantages of EAP transducer-based valves are significant over other conventional valves.

Accordingly, it would be desirable to provide EAP-based fluid control systems to further improve upon the state of the art by addressing some of the shortcomings of existing valve systems. In particular, it would be advantageous to provide EAP-based valve mechanisms which are employable in applications in which more complex valve mechanisms, such as proportional valves, are not readily used. Additionally, it would be highly advantageous to provide the EAP material in a non-wetted, fluidly sealed manner that reduces the overall form factor of the system while not decreasing its efficiency.

### SUMMARY OF THE INVENTION

The present invention includes fluid control systems and devices utilizing one or more EAP transducers to adjust or modulate at least one parameter of the fluid being controlled.

These systems and devices include at least one fluidic conduit to provide at least a portion of a flow path for allowing the fluid to travel through the system/device and one or more valves for controlling one of flow rate, flow direction, fluid temperature and combinations thereof of the fluid through the flow path. The systems and devices also include at least one EAP transducer associated with the fluidic flow path, wherein activation of the EAP transducer affects the desired fluid parameter(s).

In one variation, the fluid control system functions as a highly tunable proportional valve in which the fluid flow through the valve is proportional to the amount of voltage applied to and the displacement produced by the EAP transducer.

In another variation, the fluid control system, whether proportional or not, is operable in a non-wetted environment. To this end, the systems and devices may further include one or more barriers designed or configured to fluidly isolate a surface of the EAP transducer from constituents of the fluid being controlled by the system or device or otherwise in proximity thereto. The barrier may be designed or configured to attach to the one or more transducers or another structure of the system.

In any of the fluid control systems of the present invention, the EAP-based actuators may comprise magnetically-coupled elements to open and close valve components.

In addition to providing highly tunable devices, EAP-based actuators can be provided in very low profile and versatile form factors which make them ideal for use in complex valve designs.

The present invention also includes methods for using the subject devices and systems.

These and other features, objects and advantages of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying schematic drawings, where variation of the invention from that shown in the figures is contemplated. To facilitate understanding of the invention description, the same reference numerals have been used (where practical) to designate similar elements that are common to the drawings. Included in the drawings are the following figures:

FIGS. 1A and 1B are cross-sectional and exploded views, respectively, of a 2-way fluid control system of the present invention having a balanced configuration;

FIGS. 2A and 2B are cross-sectional and exploded views, respectively, of a 2-way fluid control system of the present invention having an unbalanced configuration;

FIGS. 3A and 3B are cross-sectional and exploded views, respectively, of a 3-way fluid control system of the present invention having a balanced configuration;

FIGS. 4A-4F are various views of a fluid control system of the present invention and several of its components;

FIGS. 5A-5D are side, perspective, cross-sectional and exploded views, respectively, of a fuel injector employing a fluid control system of the present invention;

FIGS. 6A-6C are side, perspective and cross-sectional views, respectively, of a fuel injector employing another fluid control system of the present invention;

FIGS. 7A and 7B are cross-sectional schematic representations of passive and active states of another fluid control system of the present invention employing a magnetically-coupled actuator; and

FIG. 8 is a cross-sectional view of another fluid control system of the present invention which employs a sealing spring to prevent valve leakage.

Variation of the invention from that shown in the figures is contemplated.

### DETAILED DESCRIPTION OF THE INVENTION

Exemplary embodiments and features of the inventive fluid control system and devices are now described to illustrate broadly applicable aspects of the present invention. With any variation of the invention, the fluid being controlled or acted upon by the subject devices may include one or more of a liquid, a gas, a plasma, a flowable solid, a phase change and combinations thereof.

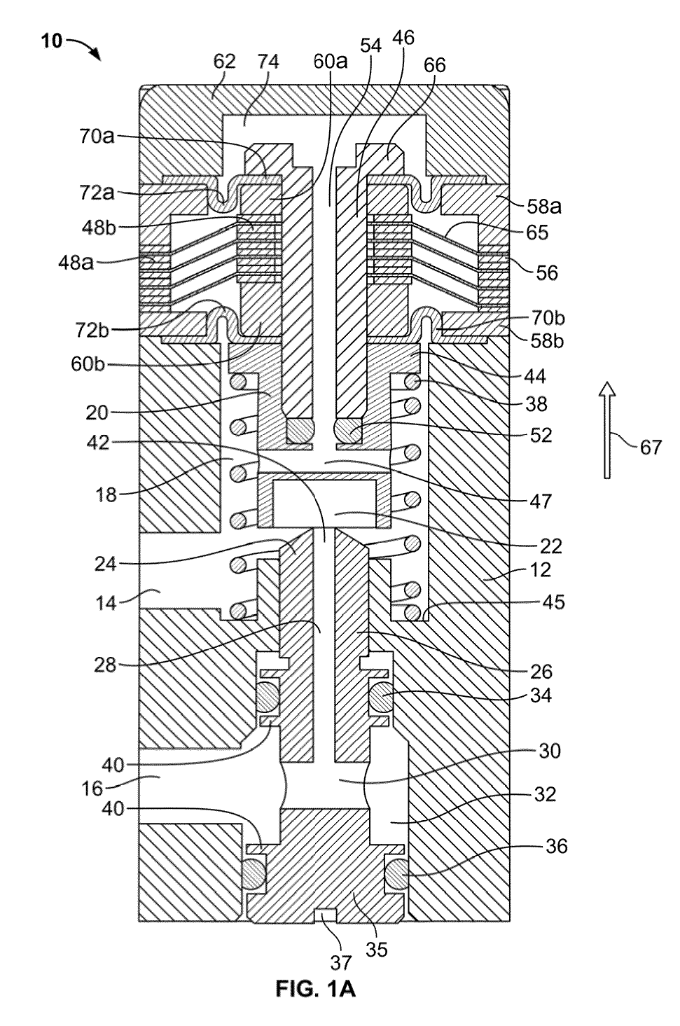

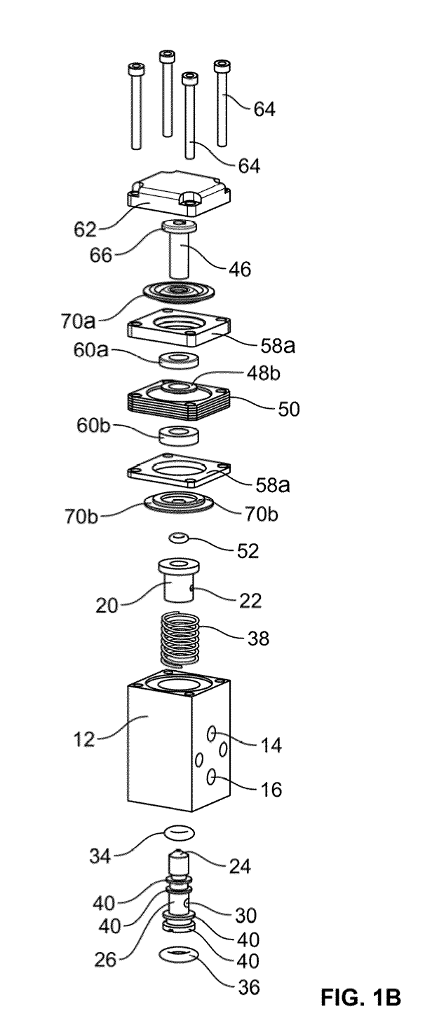

With reference to the FIGS. 1A and 1B, there is shown a fluid control system 10 of the present invention which functions as a two-way valve to allow passage of fluid from one location or chamber to another location or chamber, where the valve may be operated to allow flow in either direction through it. Fluid control system 10 includes a main housing or valve body 12 having an inlet port 14 and an outlet port 16, which may be positioned about housing 12 at any in-plane angle with respect to each other. Inlet port 14 leads to and is in fluid communication with a first or inlet chamber 18 within housing 12 and in which sits a plunger mechanism extending and movable in the axial direction of system 10. The plunger mechanism includes a poppet 20 driven by a plunger core or connection stem 46. Poppet 20 provides a centrally located, generally disc-shaped inset or seat within which a seal pad 22 is held. When the valve is in the closed position (as illustrated in FIG. 1A), seal pad 22 abuts a valve seat 24 positioned at the innermost end of stem 26 and having a cross section, e.g., tapered, to provide optimal sealing and flow stability and control. Conversely, when the valve is in the open position (not shown), a gap or spacing is provided between seal 22 and scat 24 to allow the passage of fluid from the inlet chamber 18 through an orifice 42 in valve seat 24 into axial passage 28. Passage 28 extends from valve seat 24 through the stem body 26 and is in fluid communication with a radial or lateral passage 30 extending transversely within stem body 28. Radial passage 30 opens into a second or outlet chamber 32 which in turn is in fluid communication with outlet port 16. Stem 26 may be threadably coupled to housing 12 to allow its axial position to be adjusted and, thus, allowing the pre-load placed on seal pad 22 to be adjustable or calibrated. The outer end 35 of stem 26 may provide an external detent 37 to receive a tool for this purpose. Positioned about the outer diameter of stem 26 are two O-rings 34, 36, one on each side of radial passage 30, to seal the space and prevent leakage between stem 26 and valve body 12. Grooves within or rails 40 extending from the outer surface of stem 26 may be provided to maintain the position of the O-rings, i.e., to prevent the O-rings from sliding along stem 26. A bias spring 38 is confined within the inlet chamber 18 between a radially extending shoulder 44 at the back end of poppet 20 and the forward chamber wall 45. Bias spring 38 acts to bias or preload the plunger mechanism away from valve seat 24 and defines the limit of inward movement by the plunger.

The primary fluid flow path defined by valve 10 is as follows: pressurized fluid entering inlet 14 flows into first chamber 18 and, when valve seat 24 is open, passes through it into the axial passage 28 within stem 26. The fluid then flows into outlet chamber 32 by way of the radial passage 30 within the stem, and then supplied to outlet port 16. The rate of flow of the fluid through the primary flow path is dictated by the pressure differential between inlet chamber 18 and outlet chamber 32. This system also provides a secondary fluid flow path, also referred to as a venting pathway described in detail below, for purposes of venting the primary path for the purpose of balancing the pressures between the inlet and outlet sides of the system.

The components identified and discussed thus far collectively make up a valve assembly of system 10. The valve assembly is operated by the actuator assembly 50 (identified in whole in FIG. 1B) of system 10. More specifically, the actuator acts to axially translate plunger 20 to vary the distance between poppet seal 22 and valve seat 24. The plunger core 46 is used to interface the valve assembly with the system's actuator. An O-ring 52 may be positioned between the distally or forward facing end of the plunger core 46 and an inwardly extending intermediate wall of poppet 20 to better secure the plunger core within the poppet.

Actuator 50 (identified in whole in FIG. 1B) is constructed, at least in part, from one or more EAP-based transducers 56. The transducers include an electroactive polymer film 65 comprised of two thin film electrodes having elastic characteristics and separated by a thin elastomeric dielectric polymer. The EAP film is stretched between outer and inner frame members 48a, 48b. When a voltage difference is applied to the electrodes, the oppositely-charged electrodes attract each other thereby compressing the polymer dielectric layer therebetween. As the electrodes are pulled closer together, the dielectric polymer film becomes thinner (the z-axis component contracts) as it expands in the planar directions (the x- and y-axes components expand). Furthermore, the like (same) charge distributed across each elastic film electrode causes the conductive particles embedded within that electrode to repel one another, thereby contributing to the expansion of the elastic electrodes and dielectric films.

In the illustrated exemplary embodiment, three EAP diaphragm transducers 56 are stacked together to form the actuator 50; however, any suitable number may be employed depending on the operating parameters desired. The stacked outer frames 48a of the transducers are coupled together by means of opposing outer/proximal and inner/distal clamps 58a, 58b which are in turn secured to the valve body 12 by means of housing end cap 62 and screws 64 (illustrate in FIG. 1B). The stacked inner frames 48b are coupled together by means of opposing outer/proximal and inner/distal pistons 60a, 60b which are in turn held between the head 66 of plunger core 46 and shoulder 44 of poppet 20. Pistons 60a, 60b are biased outward in the direction of arrow 67 by the force placed on plunger 20 by biasing spring 38, thereby forming a frustum-shaped actuator cartridge when in an inactive or natural state.

As explained above, when a voltage is applied to actuator 50, the diaphragm film 65 is expanded in a planar direction (perpendicular to the axial dimension of device 10) which allows the bias on spacer pistons 60a, 60b to further translate them in the direction of arrow 67. This in turn biases the core head 66 “upward” which then “lifts” the plunger mechanism along with it. The amount of lift defines the distance between the poppet seal 22 and valve seat 24. The flow rate of fluid through the valve, in turn, is proportional to the lift distance and the actuator stroke or displacement in the direction of arrow 67. Thus, the greater the stroke/displacement, the greater the flow. Because the amount of voltage applied to actuator 50 can be controlled, i.e., varied, the lift distance of the poppet can be adjusted proportionally to the applied voltage to provide a highly tuned proportional valve.

The force exerted on the plunger is dependent upon the pressure on the fluid and the orifice area of valve seat 24. When a higher pressure is desired, the amount of work (force×stroke) the actuator is capable of doing is a critical operating parameter. When a fast response or high cycle rate is necessary, the peak and average power outputs (work/time and/or work×frequency) of the actuator and power supply are two critical operating parameters.

A feature of the present invention is the provision of actuator 50 in a non-wetted environment within the overall valve system 10. To this end, fluid impermeable diaphragms are used as barriers between actuator 50 and the fluid pathway through the valve system. An outer diaphragm 70a is provided on the outer end of actuator 50 to protect it from fluid that enters into balancing or overflow chamber 74. An inner diaphragm 70b is provided between the inner end of actuator 50 and valve housing 12 and the shoulder 44 of poppet 20 to prevent contact with fluid within inlet chamber 18. The outer and inner edges of the annular diaphragms are hermetically sealed by the clamping force provided by plunger core 46 and screws 64 (illustrated FIG. 1B) to prevent any leakage of fluid into the actuator. Convolutions 72a, 72b provide the necessary slack in the barrier diaphragms to accommodate the upward displacement of spacer pistons 60a, 60b and inner actuator frames relative to clamps 58a, 58b and outer actuator frames. The convolutions extend inward within the spacing between the clamps and pistons.

As mentioned above, this valve system is further equipped with a means of venting a portion of the pressure/fluid volume from the inlet side of the system to bring it more in balance with the pressure on the outlet side of the system. This venting pathway includes a radial or lateral bore 47 extending through the diameter of poppet 20, through the lumen 54 of plunger core 46 and into balancing chamber 74 defined between cap 62 and plunger core head 66 and sealed from actuator assembly 50 by barrier diaphragm 70a. By balancing the pressure between inlet cavity 18 and balance cavity 74, the force resulting from pressure in cavity 18 and is prevented from otherwise acting upon poppet assembly 20 in the direction of arrow 67. By venting a volume of fluid from inlet cavity 18 into balancing chamber 74, the pressure within inlet cavity 18 is reduced and prevented from otherwise acting upon poppet assembly 20 in the direction of arrow 67.

There are applications in which an unbalanced valve design is preferred, such as when it is intended to function as a pressure regulator. In pressure regulated valve systems, the direction of fluid flow is typically in one direction only, with a pressure differential typically resulting by design from a greater pressure on the inlet side than on the outlet side. Such functionality is commonly used in fluid delivery systems such as automobile fuel lines, industrial automation pneumatic systems, medical breathing apparatus, etc.

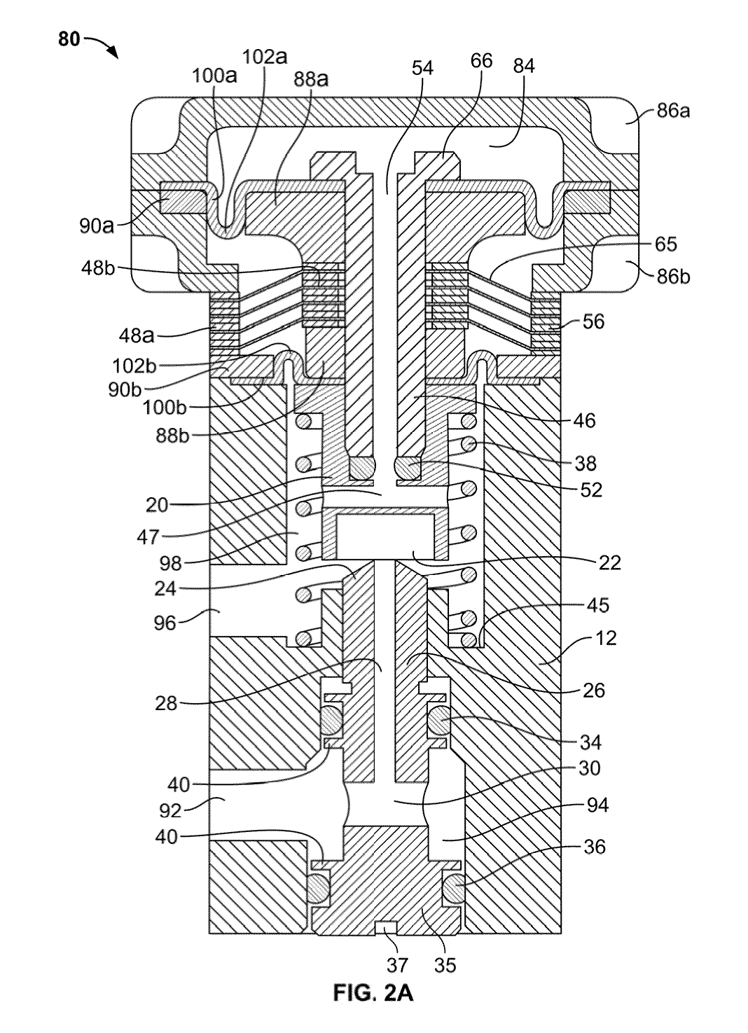

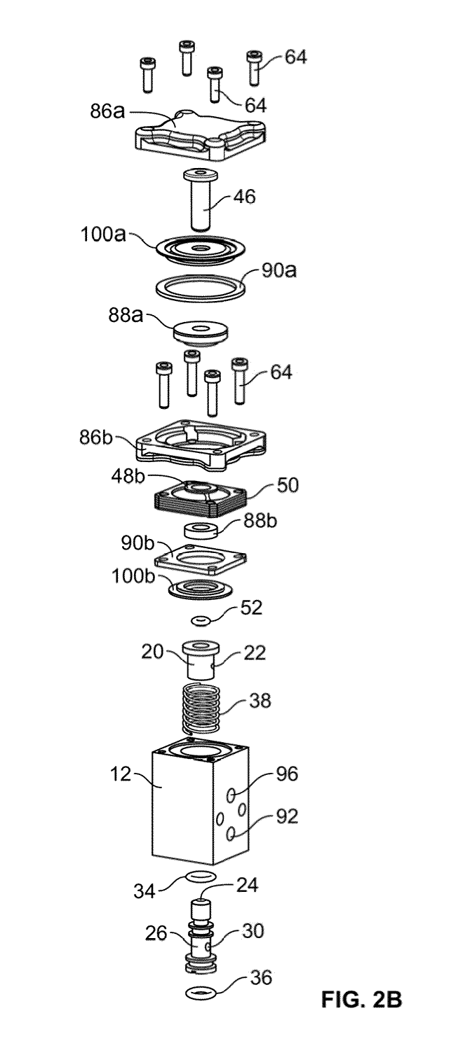

FIGS. 2A and 2B illustrate such an unbalanced valve design. Fluid control system 80 has a valve assembly and actuator assembly construct which are substantially similar that of the balanced fluid control system 10 of FIGS. 1A and 1B, where like reference numbers are used to identify like components between the two systems and, as such, may not be described again with respect to system 80.

In system 80, the direction of fluid flow is reversed from that which is illustrated for system 10, with the inlet port 92 being positioned at a more distal location on the valve body 12 than the outlet port 96. Thus, the fluid flow path defined by valve 80 is as follows. Pressurized fluid entering inlet 92 flows into inlet chamber 94 by way of radial passage 30 within the stem body 26. The fluid then passes through axial passage 28 within stem body 26. When valve seat 24 is open, the fluid enters into outlet chamber 98 then flows out of outlet port 96.

Actuator 50 (illustrated in whole in FIG. 2B) of system 80 has a construct similar to the actuator of system 10 of FIGS. 1A/1B with an EAP film 65 stretched between outer and inner frame members 48a, 48b. The stacked outer frames 48a of the transducers are coupled together by means of opposing outer/proximal and inner/distal clamps 90a, 90b which are in turn secured to the valve body 12 by means of housing end cap 62 and screws 64 (illustrated in FIG. 1B). The stacked inner frames 48b are coupled together by means of opposing outer/proximal and inner/distal pistons 60a, 60b which are in turn held between the head 66 of plunger core 46 and shoulder 44 of poppet 20. Pistons 60a, 60b are biased outward in the direction of arrow 67 by the force placed on poppet 20 by biasing spring 38, thereby forming a frustum-shaped actuator cartridge when in an inactive or natural state.

The larger internal dimensions of the assembled end cap provide a clearance between the inner wall of the end cap and outer/proximal piston 88a which is greater than the clearance between inner/distal piston 88b and inner/distal transducer clamp 90b. As such, and unlike the balanced system of FIGS. 1A/1B, the volume of overflow chamber 84 is greater than outlet chamber 98.

Pressure regulating functionality is obtained by use of the outlet pressure as a controlling element by means of creating a closing force between poppet 22 and orifice 24 resulting from the larger pressure area of outer diaphragm (100a, 102a) creating a greater force, counteracting the weaker resultant force from the smaller inner diaphragm (100b, 102b), the two opposing forces are coupled though the outer piston 88a, the actuator stack 50 and inner piston 88b. The combination of the force resulting from this pressure imbalance, the force of the EPAM actuator and the force of the bias spring 38 results in a system at equilibrium which can be altered by two means—a pressure change in the balance chamber 84 which communicates with the outlet port through passages 54 and 47 or application of a voltage to the EPAM actuator.

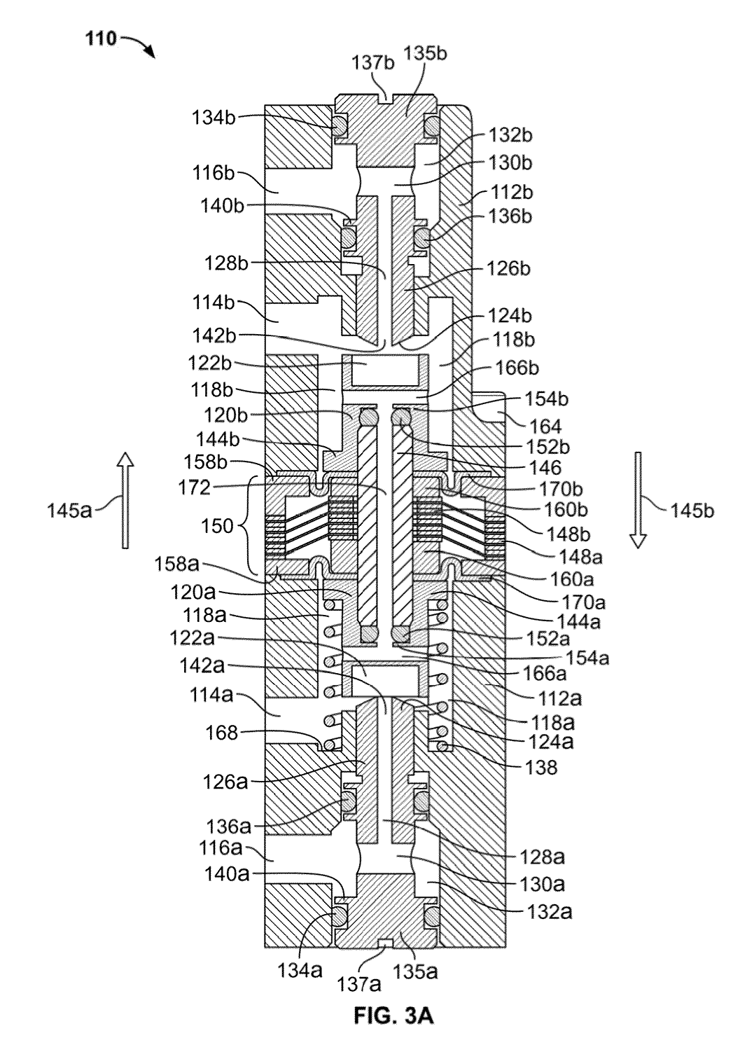

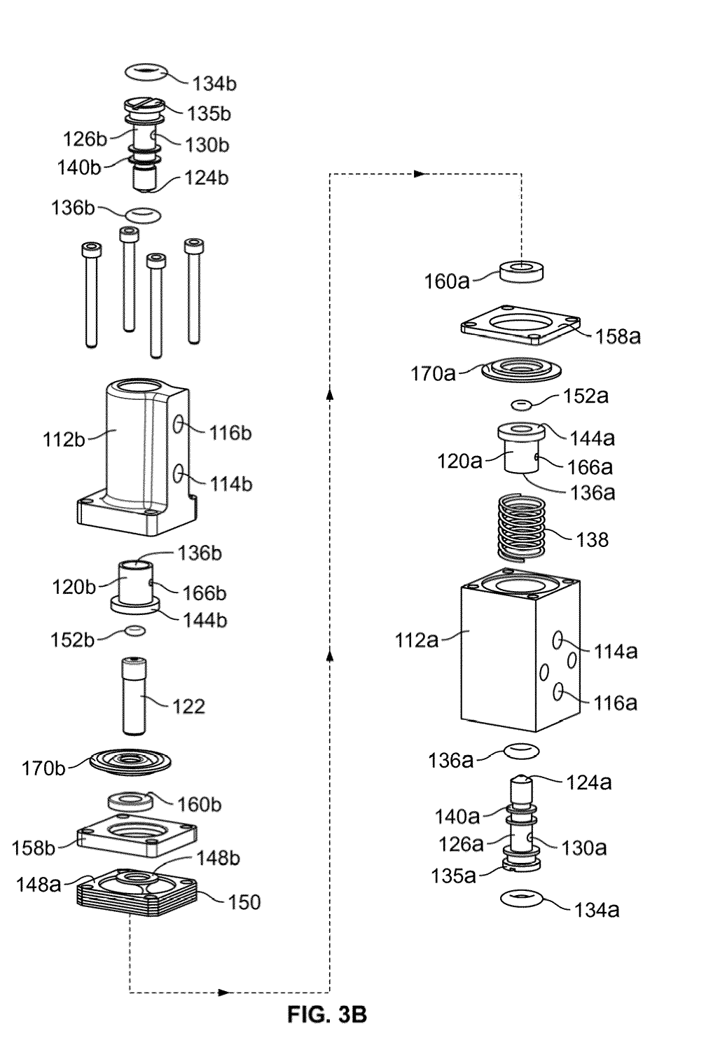

FIGS. 3A and 3B illustrate a fluid control system 110 of the present invention having a balanced configuration and which allows passage of fluid between three locations, where the direction of fluid flow is controlled by the operation of two valves. Fluid control system 110 includes two valve bodies 112a, 112b (which are referred to respectively herein as a lower valve body and an upper valve body based solely on the point of reference of the figures, where such nomenclature does not limit or require use of the system in such a lower/upper orientation) positioned on opposing sides of an actuator assembly 150, which are collectively secured together by screws 164 (shown in FIG. 3B only). While two valves are employed, only a single poppet/plunger mechanism extending between the valve bodies is used. The plunger mechanism is primarily defined by a plunger core 146 extending between symmetrically disposed lower and upper poppets 120a, 120b. The plunger mechanism is configured to operate bi-directionally to respectively open and close the system's two valves.

The construct of the two valve body portions 112a, 112b are substantially similar; however, only one of them (112a) houses a bias spring for biasing the actuator, i.e., in the direction of arrow 145a. The designs of the valve bodies are now described collectively. Each valve body has an inlet port 114a, 114b, respectively, and an outlet port 116a, 116b, respectively, which ports may be positioned about there respective housings at any angle with respect to each other. In the illustrated example, inlet ports 114a, 114b are used in tandem whereby fluid enters both ports simultaneously from one or more sources, and whereby the outlet ports 116a, 116b are used separately, flow rate of one being the inverse of the other. Rather, as will be better understood from the discussion below, fluid control system 110 attenuates the amount of fluid exiting each outlet port whereby one outlet port may be completely closed (outlet port 114a) while the other is completely open (outlet port 114b), or where both outlet ports may be partially open to varying degrees relative to each other. Alternatively, the system may be configured such that ports 114a, 114b are employed as fluid outlets and ports 116a, 116b are used as fluid inlets. Such a versatile system enables three-way fluid control.

Each inlet port 114a, 114b leads to and is in fluid communication with an annularly configured first or inlet chamber 118a, 118b, within which sits the poppet component 120a, 120b of the poppet/plunger mechanism. Each poppet 120a, 120b provides a centrally located, generally disc-shaped inset within which a seal pad 122a, 122b is held. When a valve is in the closed position (such as the lower valve 112a is illustrated in FIG. 2A), seal pad 122a, 122b abuts a tapered valve seat 124a, 124b positioned at the innermost end of stem 126a, 126b. Conversely, when the valve is in the open position (such as the upper valve 112b is illustrated in FIG. 2A), a gap or spacing is provided between seal 122a, 122b and seat 124a, 124b to allow for the passage of fluid from the inlet chamber 118a, 118b through an orifice 142a, 142b in valve seat 124a, 124b into an axial passage 128a, 128b. Passage 128a, 128b extends from valve seat 124a, 124b through stem body 126a, 126b and is in fluid communication with a radial or lateral passage 130a, 130b extending transversely within stem body 126a, 126b. Radial passage 130a, 130b opens into a second or outlet chamber 132a, 132b which in turn is in fluid communication with outlet port 116a, 116b. To maintain a pressure balance between the two inlet sides of system 110, fluid communication is provided between the two sides by way of lumen 172 within plunger core 146 and passages 166a, 166b extending laterally through the diameter of each of poppets 120a, 120b.

Stems 126a, 126b may be threadably coupled to their respective housings 112a, 112b to allow for adjustment of their axial positions and, thus, allow for the pre-load placed on seal pads 122a, 122b to be adjustable. The outer ends 135a, 135b of stems 126a, 126b may have an external detent 137a, 137b to receive a tool for this purpose. Positioned about the outer diameter of each stem 126a, 126b are two O-rings 134a, 134b and 136a, 136b, one on each side of radial passage 130a, 130b, to seal the space and prevent leakage between stem 126a, 126b and valve body 112a, 112b. Grooves in or rails on 140a, 140b the outer surface of stem 126a, 126b may be provided to maintain the position of the O-rings, i.e., to prevent the O-rings from sliding along the stem.

As mentioned above, because only a single plunger mechanism is employed with this system, only a single actuator assembly 150 is necessary; however, multiple actuator systems are also within the scope of the present invention. Actuator assembly 150 includes an actuator having a stacked set of transducers similar to that of the two previously-described fluid control systems. The stacked outer transducer frames 148a are coupled and held together by means of opposing lower and upper clamp structures 158a, 158b which are in turn held between the valve bodies 112a, 112b. The inner transducer frames 148b are coupled together by means of opposing lower and upper pistons 160a, 160b which are in turn held between lower and upper poppet shoulders 144a, 144b. A bias spring 138 is confined within inlet chamber 118a between poppet shoulder 144a and the forward chamber wall 168. Bias spring 138 acts to force poppet 120a in the direction of arrow 145a, which moves pistons 160a, 160b in the same direction, thereby biasing or preloading the actuator in the frustum configuration discussed previously. As such, actuator assembly 150 acts to axially translate the plunger core 146 to vary the distance, respectively, between the poppet seals 122a, 122b and their opposing valve seats 124a, 124b. O-rings 152a, 152b may be positioned between the respective ends of the plunger core 146 and inwardly extending intermediate shoulders 154a, 154b of poppet 120a, 120b to further secure the plunger core within the plunger mechanism.

In one variation, the natural bias on the actuator, i.e., when the actuator is in an inactive state, is selected to maintain the plunger mechanism in an axial position whereby one valve (the lower valve in the illustrated embodiment) is normally closed while the other valve (the upper valve in the illustrated embodiment) is normally open. When a voltage is applied to the actuator, the transducer films are expanded in a planar direction, which allows them to be further stretched thereby enabling the plunger mechanism as a whole to translate further in the direction of arrow 145a and thereby moving lower poppet seal 122a away from lower valve seat 124a and moving upper poppet seal 122b toward upper valve seat 124b. The amount of translation undergone by the plunger mechanism in either axial direction 145a or 145b can be controlled to thereby selectively vary tile distance between the poppet seals 122a, 122b and their opposing valve seats 124a, 124b. The respective fluid flow rates from the inlet ports to the outlet ports can thus be attenuated as desired.

As with the other fluid control systems of the present invention, system 110 may be configured with the actuator assembly 150 in a non-wetted environment. To this end, lower and upper hermetically sealed and convoluted barrier diaphragms 170a, 170b are provided across the outer frame clamps and plunger pistons of actuator 150 to protect it from fluid entering into inlet chambers 118a, 118b.

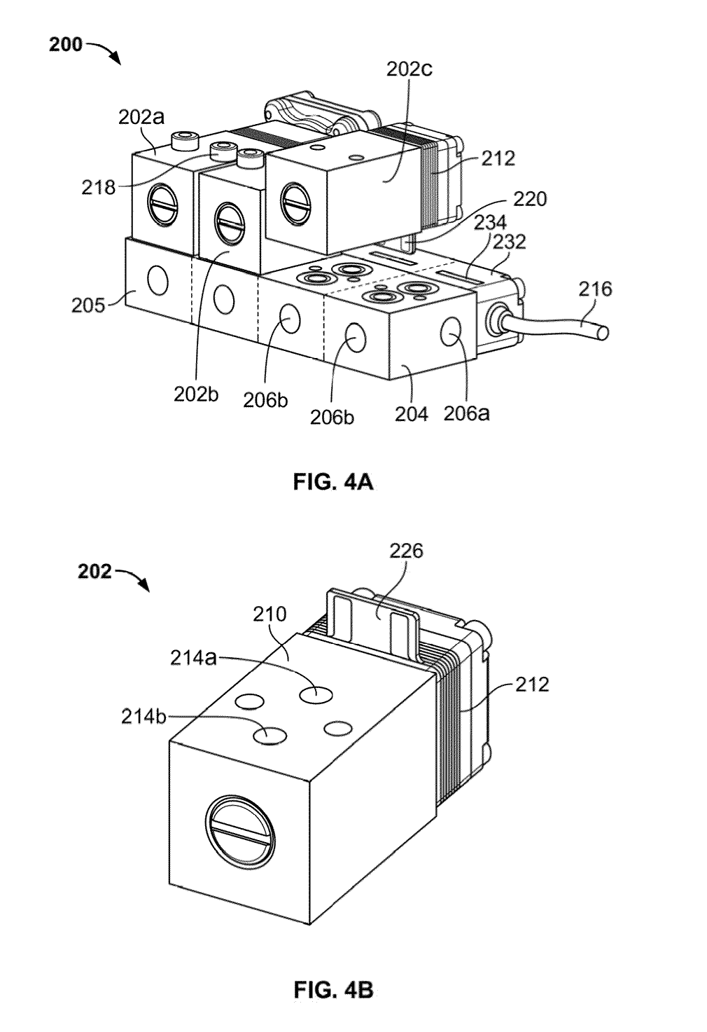

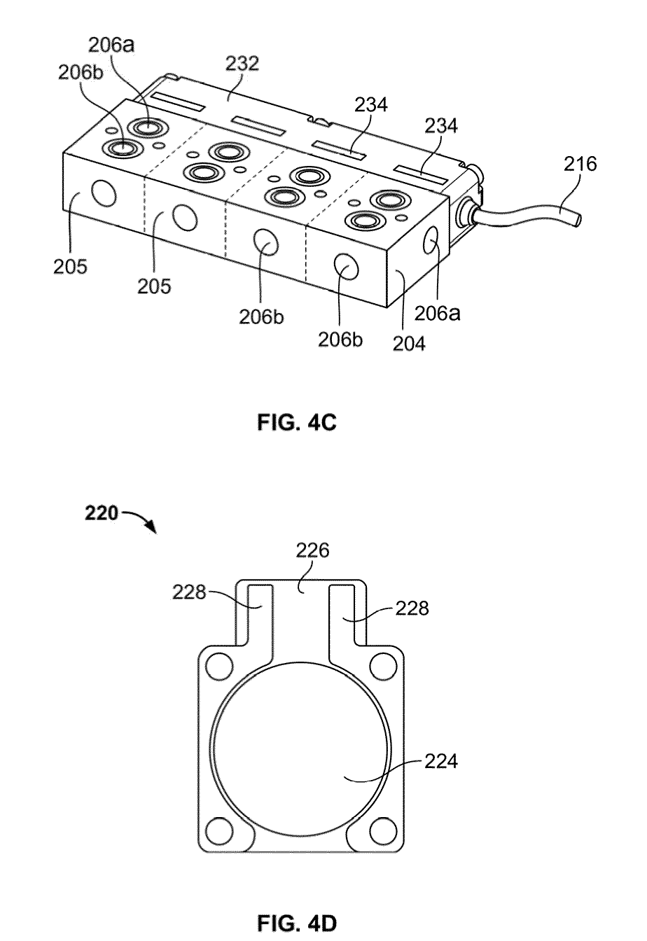

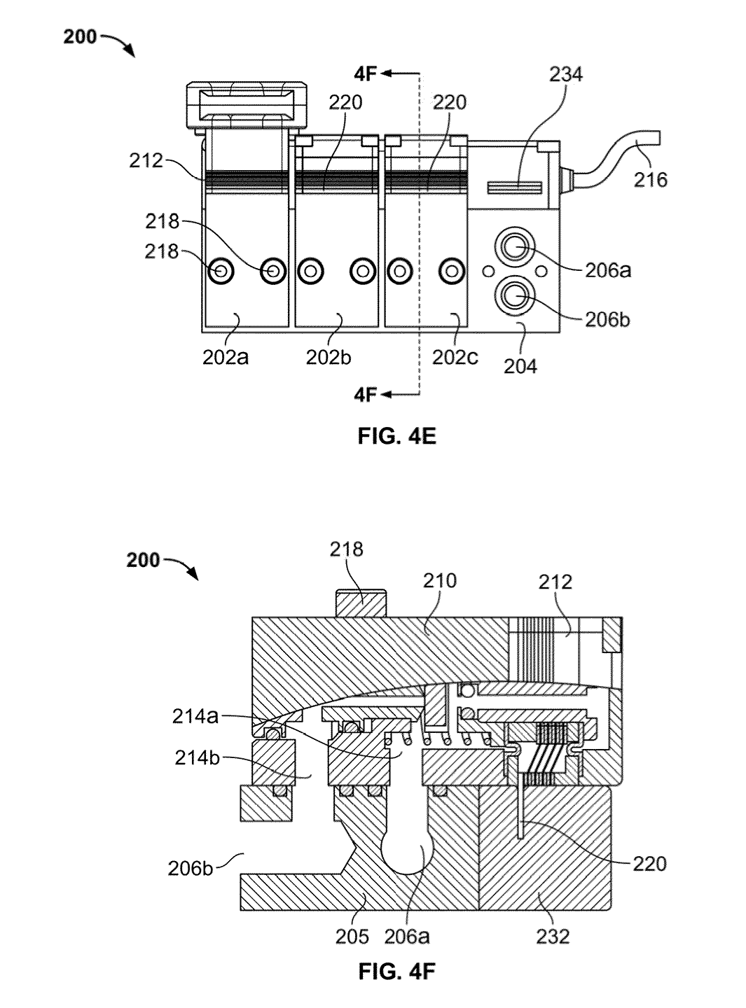

FIGS. 4A-4F illustrate a master fluid control system 200 of the present invention for complex fluid control applications involving the movement of fluid to and from multiple locations and sources. Such a system may be useful in dividing an incoming flow into two outputs for proportional position or velocity control of a fluid motion system.

System 200 includes a plurality of fluid control devices 202 of the present invention integrated with a fluid manifold block 204. The fluid control devices 202 include regulators 202a (such as the regulator of FIGS. 2A/2B) and/or valves 202b, 202c (such as the valve devices of FIGS. 1A/1B). As illustrated in FIG. 4D, each of the fluid control devices 202 has two fluid inlet-outlet ports 214a, 214b within the valve body 210 where one port is used for fluid inlet and the other for fluid outlet. The fluid manifold block 204 may include any number of manifold portions 205 to accommodate the number of fluid control devices 202 to be used. Each manifold portion 205 has two fluid inlet-outlet ports 206a, 206b, where port 206a functions as an inlet port and port 206b functions as an outlet port when coupled to a valve device 202, and visa-versa when coupled to a regulator device 202. As all ports 206a within manifold block 204 are in serial alignment and fluid communication, they collectively function as a shared pressure rail which can receive flow at regulated pressure from the outlet of a regulator 202a connected to any of the ports 206a. When system 200 is assembled, each pair of valve inlet-outlet ports 214a, 214b is aligned with a corresponding pair of manifold inlet-outlet ports 206a, 206b. The control devices 202 are each mechanically secured to manifold block 204 by way of fasteners 218.

System 200 further includes an electrical interconnect block 232 mechanically interfaced with fluid manifold block 204. Electrical interconnect block 232 provides all necessary electrical and electronic coupling between the subject regulators and valves 202a-202c and the system's power supply (not shown) and electronic controls (e.g., ICU, etc.) (not shown) via electrical cable 216. Electrical interconnect block 232 are electronically coupled to and the valve/regulators 202 via electrical connection slots 234 within block 232. Slots 234 are configured to receive the corresponding electrical connection tabs 220 extending from the actuator portions 212 of the respective valves/regulators 202. As best illustrated in FIG. 4D, each connection tab 220 comprises a printed circuit board (PCB) 226 having an opening 224 configured to frame an EAP actuator transducer (not shown). Electrical traces 228 are provided on the PCB 226 for establishing the electrical connection with the transducer electrodes.

The manifold inlet-outlet port pairs 205 are selectively employed by the system via the electronic controls to move and direct fluid, where the movement of a single type of fluid between various different sources and destinations is controlled, e.g., an industrial pick and place unit, or where multiple fluid types are selectively moved from various sources to one or more depositories, e.g., gas sampling equipment.

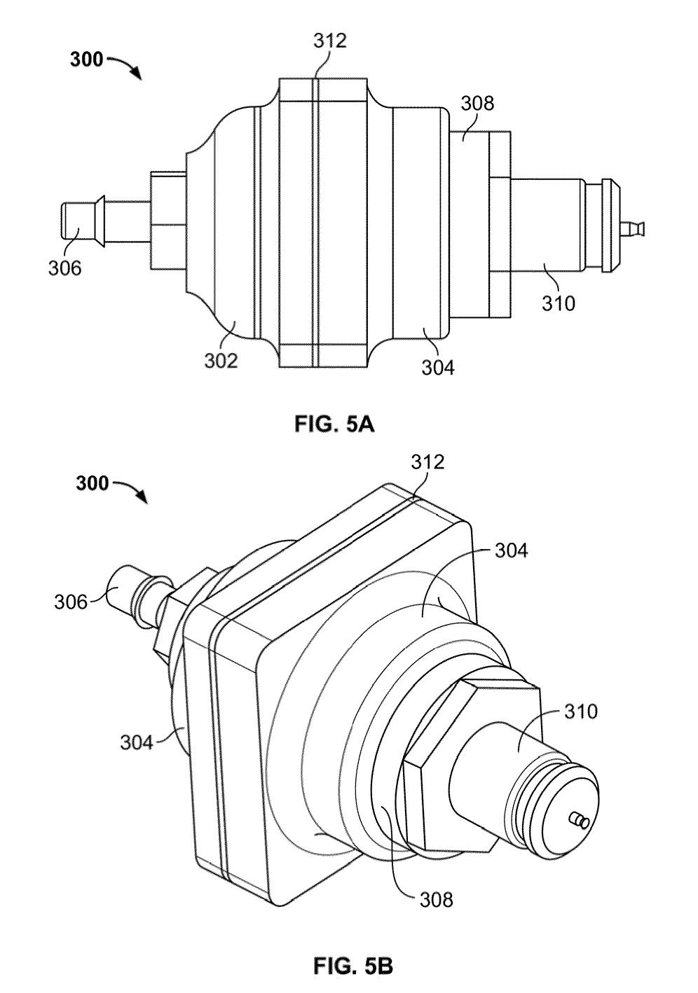

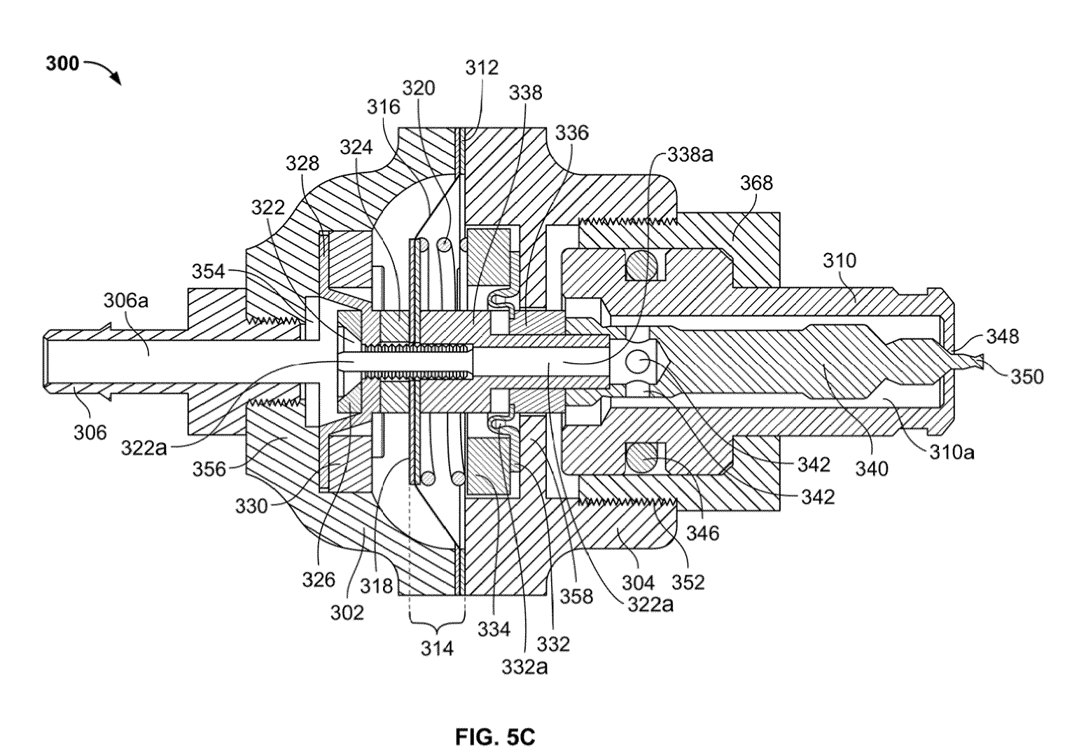

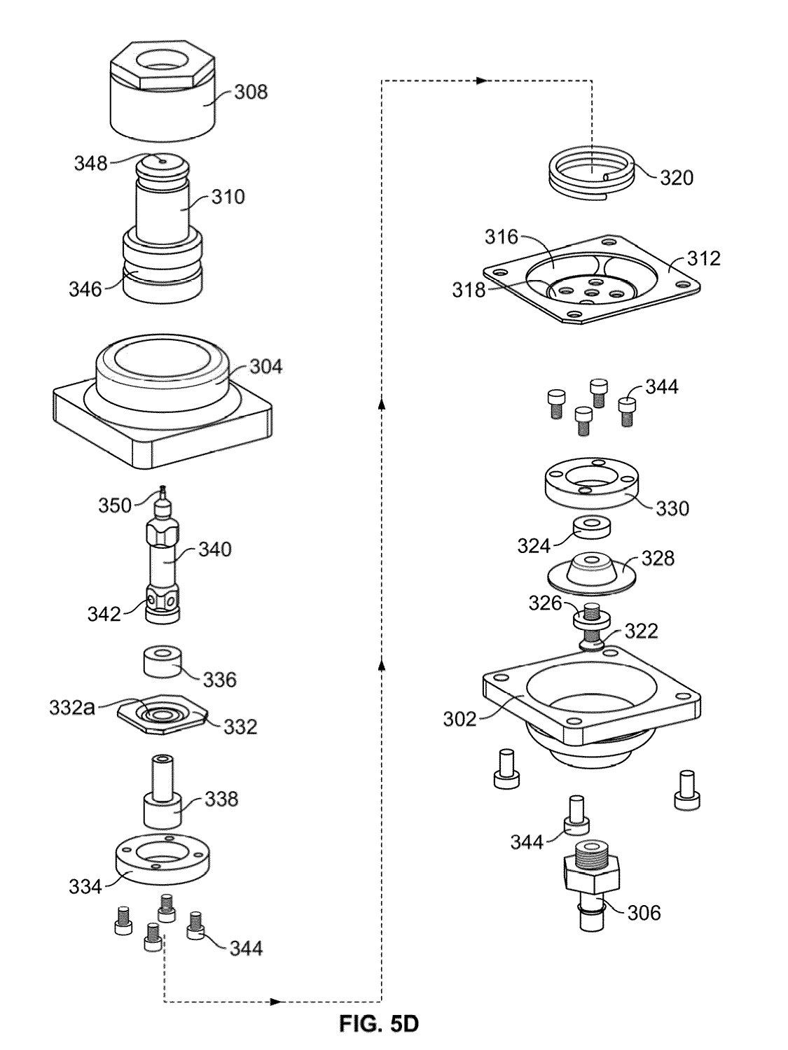

The fluid control devices of the present invention are ideally suited for use in fuel injector applications. FIGS. 5A-5D illustrate a non-wetted valve device of the present invention integrated within a fuel injector device 300. The inlet portion of fuel injector housing generally includes inlet body 302 and inlet fitting 306. The outlet portion of the injector housing generally includes a fixed outlet body 304, an adjustable outlet body 308 and injector head 310. The axial position of adjustable outlet body 308 relative to fixed outlet body 304 is adjustable by way of threads 352. An o-ring 346 may be positioned between adjustable housing 308 and injector head 310 to further secure the head within the housing. Various sets of fasteners 344 (see FIG. 5D) are used to secure the housing and other components together.

The internal structure of the fuel injector is best described with reference to FIGS. 5C and 5D. The fluid pathway within the injector begins with inlet passageway 306a which extends through a thru-hole 322a within screw 322. The fluid passageway extends within an axial passageway 338a of a coupling 338 which is threadedly engaged with screw 322. The fluid passage way further extends within a pentel 340 which has radially-extending flow passage holes 342. The passage holes 342 open into an outlet chamber 310a within head portion 310 of the injector. Fluid is allowed to flow out of an opening 348 within the distal end of head 310 when the pentel tip 350 is moved proximally (toward the inlet side of the injector) away from opening 348.

The axial movement of pentel 340 is controlled by EAP actuator 314 which encircles screw 322 and coupling 338. Actuator 314 includes a transducer cartridge comprised of an EAP film 316 extending between outer and inner frame members 312, 318, respectively. Outer frame 312 is held between the inlet and outlet housings 302, 304 of the injector. Inner frame 318 is held between a washer 324 held by the head of screw 322 and the proximal end of coupling 338. Inner frame 318 is biased toward the inlet side of the injector by a coil spring 320. When the actuator is inactive, pentel tip 350 extends through head opening 348, i.e., the injector head is normally closed. When the actuator 314 is activated, screw 322, coupling 338 and pentel 340 are moved in the proximal direction, thereby moving pentel tip 350 out of head opening 348 and enabling fluid within chamber 310 a to exit the fuel injector. The extent to which the fuel injector is open or closed is dependent upon the amount of voltage applied to actuator 314, where the fully open and fully closed positions of pentel 340 can be manually calibrated by adjusting the either or both of the position of adjustable housing 308 relative to outlet body 304 (by way of threads 352) and the position of coupling 338 relative to screw 322 (by way of the screw threads).

Actuator 314 is provided in a non-wetted environment by proximal and distal diaphragms 328 and 332, respectively, the latter of which has a convolution 332a. The inner portion of proximal diaphragm 328 is secured between washer 324 and a countersink washer 326 on the underside of screw head 322. The peripheral portion of proximal diaphragm 328 is secured between diaphragm clamp 330 and an inner wall 356 of inlet body 302. The inner portion of distal diaphragm 332 is secured within washer 336. The peripheral portion of distal diaphragm 332 is secured between diaphragm clamp 334 and an internally-extending shoulder 358 of outer housing body 304.

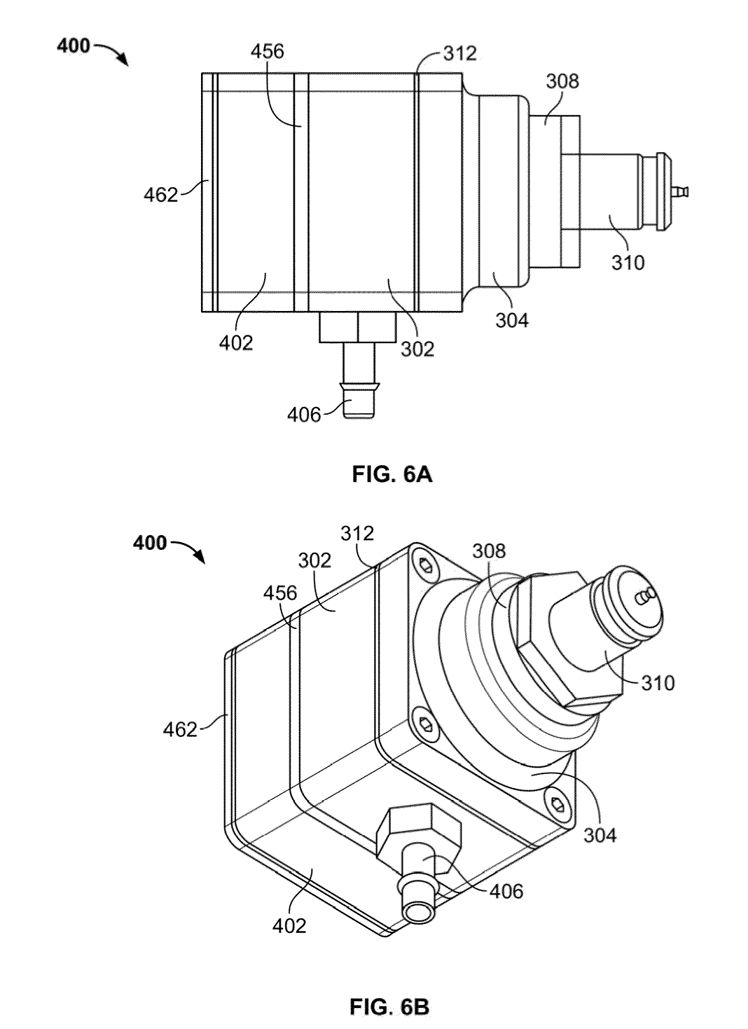

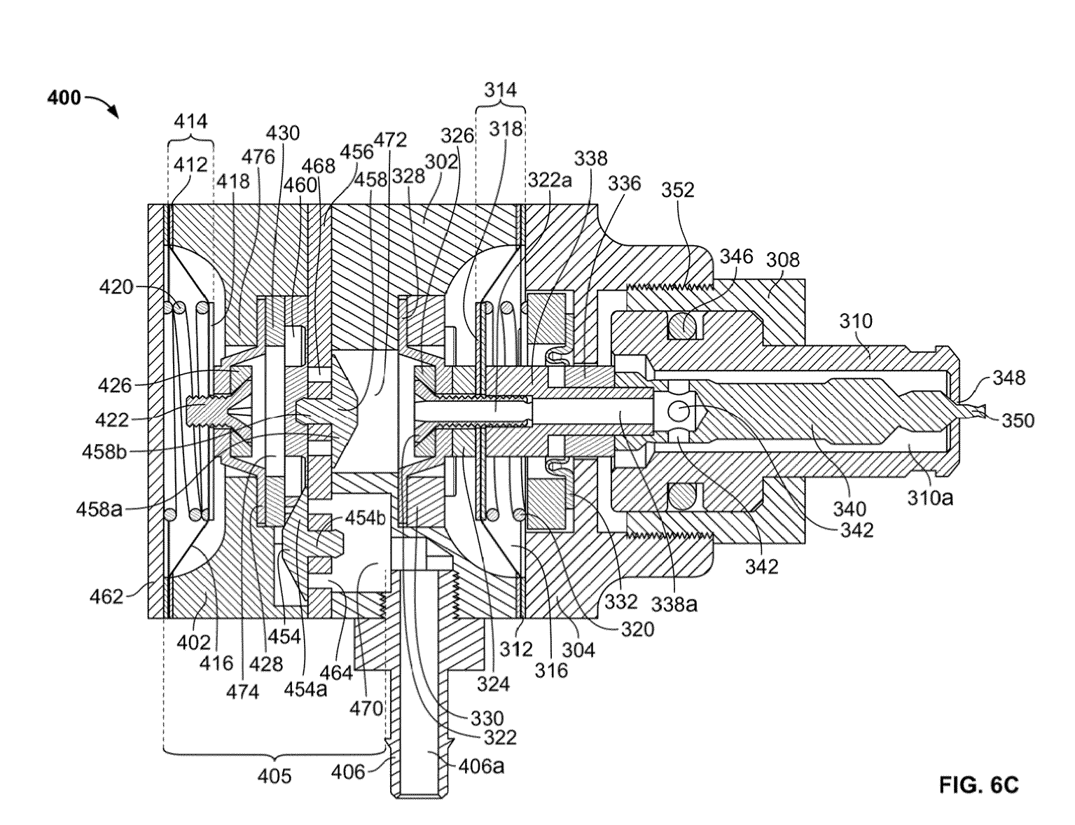

FIGS. 6A-6C illustrate another fuel injector 400, constructed and functioning similarly to that of fuel injector 300 (with like number referencing similar components) with the addition of an EAP-based pump mechanism 405 of the present invention. Pump 405 regulates fluid inflow from inlet passageway 406a of inlet fitting 406 into the injector. Pump mechanism 405 is housed within a pump housing 402 positioned on the proximal end of injector inlet body 302. These two portions of the injector are physically integrated by way of a pump plate 456. An end cap 462 covers the proximal end of pump housing 402.

Pump mechanism 405 includes inlet and outlet chamber 470 and 472, respectively. An inlet valve 454 enables fluid passage from the inlet chamber 470 into an intermediate or pumping chamber 474 by opening thru-holes 464 within pump plate 456, and an outlet valve 458 enables fluid passage from the pumping chamber 474 to the outlet chamber 472 by opening thru-holes 468 within valve plate 456. Inlet and outlet valves are oppositely facing umbrella valves having flexible caps 454a, 458b and stem portions 454b, 458b which are held within valve plate 456. The relative fluid pressure within intermediate chamber 474 dictates the opening and closing of valves 454 and 458, respectively. Specifically, a positive pressure in chamber 474 pushes down on cap 454a, thereby keeping thru-holes 464 sealed, and pushes up on cap 458a, thereby unsealing thru-holes 468. Fluid flow into and out of the intermediate chamber 474, and thus fluid pressure therein, is controlled by the axial movement of screw 422 which in turn is controlled by EAP-based actuator 414.

Actuator 414 includes a transducer cartridge comprised of an EAP film 416 extending between outer and inner frame members 412, 418, respectively. Outer frame 412 is held between the pump housings 402 and enc cap 462. Inner frame 418 is positioned between biasing spring 420 and the underside of the head of screw 422 and also serves to secure the inner portion of pumping diaphragm 428. The inner portion of diaphragm 428 is further secured by countersink washer 426. The peripheral portion of diaphragm 428 is secured between a diaphragm clamp 430 and an inwardly-extending shoulder 476. Fasteners 460 secure diaphragm 428 and diaphragm clamp 430 to shoulder 476.

When actuator 414 is activated, screw 422 moves axially between a minimum or proximal position and a distal or maximum travel position, with pumping diaphragm 428 expanding and compressing, respectively, thereby increasing and decreasing the volume of pumping chamber 474. As the volume of chamber 474 increases, a negative pressure is created within it and fluid flows from inlet chamber 470, through thru-holes 464 and into intermediate chamber 474. As the volume of chamber 474 is decreased, a positive pressure is created within it causing fluid to flow from it into outlet chamber 472. Fluid in the outlet chamber then flows into passage 322a within injector screw 322. The remainder of the fluid passage through injector 400 is the same as described with respect to injector 300 of FIGS. 5A-5D.

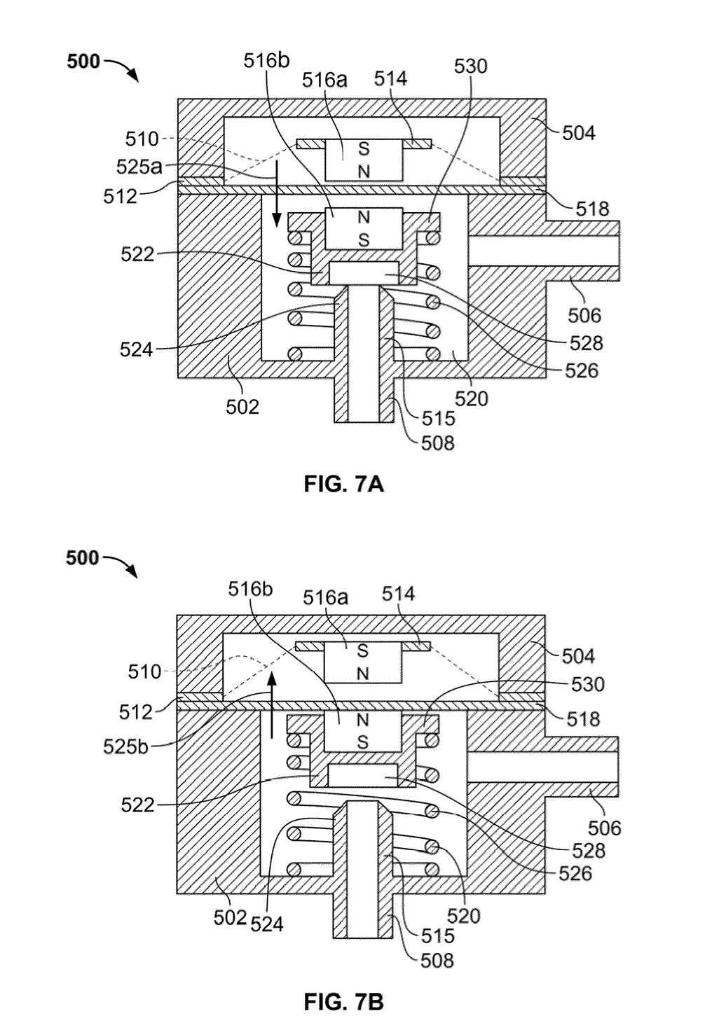

FIGS. 7A and 7B illustrate another fluid control device 500 of the present invention employing a magnetically-coupled actuator to open and close a valve. Device 500 includes a valve body 502 having a fluid chamber 520 and inlet and outlet ports 506 and 508, respectively, in fluid communication therewith. The inlet end of outlet port 508 defines a valve stem 515 terminating in a valve orifice or seat 524. A poppet assembly 522 positioned within chamber 515 sits atop valve stem 515 with a poppet seal 528 abutting orifice 524 when in a closed position (as shown in FIG. 7A). An actuator housing 504 is mounted to valve body 502, the two of which are separated by a thin plate 518. Plate 518 is made of a non ferrous material and is sufficiently strong to withstand fluid pressure within fluid chamber 520. Actuator housing 504 contains EAP transducer which is formed by an EAP film 510 extending between outer and inner frame members 512 and 514, respectively. Outer frame member 512 is held between actuator housing 504 and plate 518. Inner frame member 514 carries a centrally disposed magnet 516a having its poles (N-S) axially aligned with the poppet-valve mechanism. A second magnet 516a situated on the opposite side of plate 518 is carried by poppet assembly 522. The second magnet 516a is axially aligned such that one pair of like poles, e.g., the north poles (N), of the magnets oppose each other, thereby biasing the transducer inner frame 514 and poppet assembly 522 away from each other. At the same time, a biasing spring 526 held between an inner wall of valve housing 502 and a shoulder 530 radially extending from poppet assembly 522 biases the poppet assembly and second magnet 516b away from valve seat 524 and towards the transducer and the first magnet 516a.

When the actuator is in a passive or inactive state (as shown in FIG. 7A), the biasing force of the transducer film 510 against the first magnet 516a is greater than the biasing force of the spring 526 against the second magnet 516b, with the net force being in the direction of arrow 525a (of FIG. 7A). As such, when the actuator is inactive, poppet 528 is forced against and closes valve orifice 524. Upon activation of the actuator (as illustrated in FIG. 7B), film 510 expands enough such that the spring bias is greater than the film bias, with the net force now being in the opposite direction—in the direction of arrow 525b (of FIG. 7B). As such, the two magnets are moved in that direction and poppet 528 is moved away from and opens valve orifice 524, thereby allowing fluid within chamber 520 to exit outlet port 506.

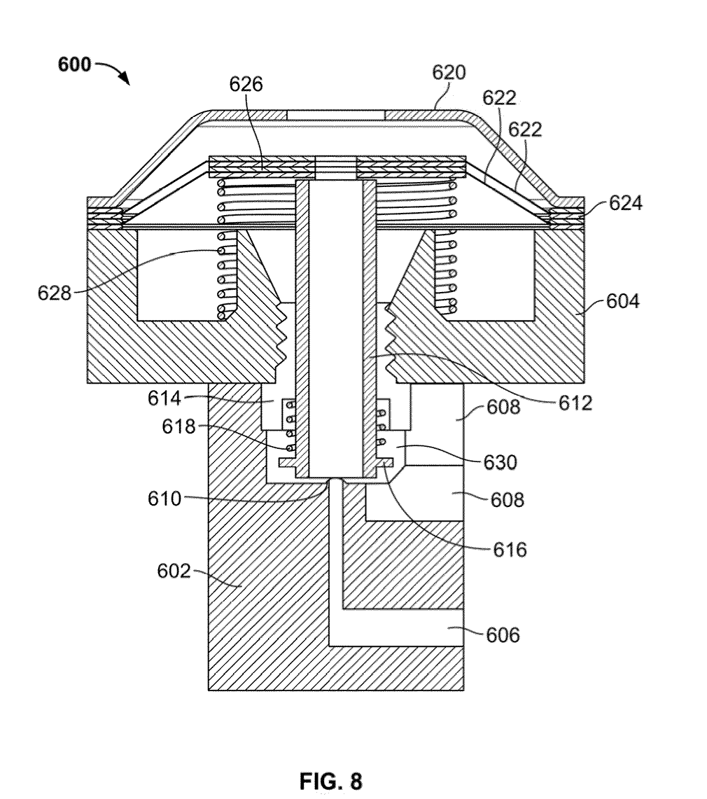

With the valve systems just described that having a normally closed configuration, the bias force placed on the poppet seal by the system's actuator is the sole force maintaining the valve orifice in a closed state. As such, any variation in the actuator's components, e.g., variation in film compliance, spring force, etc., may result in a less than necessary net bias force to maintain the seal between the poppet and the valve orifice. The fluid control device 600 of FIG. 8 provides one manner in which to rectify such a possibility.

Fluid control device 600 includes a valve housing 602 and an actuator housing 604 coupled together by connector 614. Valve housing 602 defines a fluid chamber 630 and has an inlet port 606 and an outlet port 608. Actuator housing 604 houses an actuator which may include one or more transducers. Here, the actuator is formed by two stacked transducers, each comprising an EAP film 622 extending between outer and inner frame members 624 and 626, respectively. The outer transducer frames 624 are held between housing 604 and a cover 620. Extending from the inner frames 626 axially through connector 614 and into fluid chamber 630 within the valve housing is a poppet 612. A biasing spring 628 positioned between the underside of frames 626 and an inner wall of housing 604 biases poppet 612 away from valve orifice 610; however, the bias of the transducer films 622 is greater than that of bias spring, and thus, the distal end of poppet 612 sits against valve orifice 610 when the actuator is inactive, i.e., the valve is normally closed. As mentioned previously, with any variation in the actuator forces which may reduce the net bias force necessary to ensure that poppet 612 seats against valve orifice 610, allowing leakage through the orifice from inlet port 606 to enter chamber 630. To obviate such, device 600 includes a sealing spring 618 encircling the distal end of poppet 612 and which is held between a shoulder within connector 614 and a shoulder 616 extending radially from the distal end of poppet 612. The bias force of sealing spring 618 is sufficient to compensate for any variance in the actuator bias force to ensure that poppet 612 seals against orifice 610 when the actuator is inactive. When the actuator is activated, EAP films 622 are expanded enabling the bias force of actuator spring 628 to over come that of sealing spring 618, thereby moving poppet 612 axially away from orifice 610. Fluid may then travel from inlet port 606, to chamber 630 and exit outlet port 608.

Methods of the present invention associated with the subject fluid control systems, devices, components and assemblies are contemplated. For example, such methods may include transferring fluid from one chamber to another, selectively controlling the opening of a valve a distance proportional to the displacement of the valve's actuator, controlling the flow rate of fluid through a valve system, venting fluid from a chamber of a valve assembly, etc. The methods may comprise the act of providing a suitable device or system in which the subject inventions are employed, which provision may be performed by the end user. In other words, the “providing” (e.g., a valve assembly, actuator, etc.) merely requires the end user obtain, access, approach, position, set-up, activate, power-up or otherwise act to provide the requisite device in the subject method. The subject methods may include each of the mechanical activities associated with use of the devices described as well as electrical activity. As such, methodology implicit to the use of the devices described forms part of the invention. Further, electrical hardware and/or software control and power supplies adapted to effect the methods form part of the present invention.

Yet another aspect of the invention includes kits having any combination of devices described herein—whether provided in packaged combination or assembled by a technician for operating use, instructions for use, etc. A kit may include any number of valve systems according to the present invention. A kit may include various other components for use with the valve systems including mechanical or electrical connectors, power supplies, etc.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Stated otherwise, unless specifically defined herein, all technical and scientific terms used herein are to be given as broad a commonly understood meaning as possible while maintaining claim validity.

In all, the breadth of the present invention is not to be limited by the examples provided. That being said, we claim:

1. A fluid control device comprising:
a valve seat;
a poppet; and
at least one electroactive polymer actuator for selectively controlling the distance between an end of the poppet and the valve seat.

2. The fluid control device of claim 1, further comprising:
an inlet fluid chamber;
an outlet fluid chamber;
an overflow chamber; and
a venting passageway between the inlet fluid chamber and the overflow chamber, wherein the passage of fluid from the inlet fluid chamber and the overflow chamber affects the fluid pressure within the device.

3. The fluid control device of claim 2, wherein the inlet fluid chamber and the overflow chamber have substantial similar volumes.

4. The fluid control device of claim 2, wherein tile volume of the overflow chamber is greater than that of the inlet fluid chamber.

5. The fluid control device of claim 3, wherein the fluid control device functions as a regulator.

6. The fluid control device of claim 1, wherein the actuator is provided in a non-wetted environment.

7. The fluid control device of claim 6, further comprising a first barrier diaphragm between the inlet fluid chamber and the actuator and a second barrier diaphragm between the actuator and the overflow chamber.

8. The fluid control device of claim 1, further comprising a spring mechanism for biasing the poppet against the valve seat when the actuator is inactive.

9. The fluid control device of claim 1, wherein the poppet and actuator are magnetically coupled.

10. A fluid control device of claim 1, comprising:
first and second inlet chambers,
first and second outlet chambers;
a first valve mechanism positioned between the first inlet chamber and the first outlet chamber, the first valve mechanism having a first valve seat;
a second valve mechanism positioned between the second inlet chamber and the second outlet chamber, the second valve mechanism having a second valve seat;
a poppet extending between the first and second valve seats; and
at least one electroactive polymer actuator for selectively controlling movement of the poppet between the first and second valve seats.

11. The fluid control device of claim 10, wherein the at least one actuator is provided in a non-wetted environment.

12. The fluid control device of claim 11, further comprising a first barrier diaphragm between the inlet fluid chamber and the actuator and a second barrier diaphragm between the actuator and the overflow chamber.

13. A fluid control system comprising:
a fluid manifold block having at least two pairs of inlet and outlet ports; and
at least two fluid control devices of claim 1, each device having a pair of inlet and outlet ports, wherein a device inlet port is in fluid communication with a manifold block inlet port and a device outlet port is in fluid communication with a manifold block outlet port.

14. The fluid control system of claim 13, further comprising an electrical interconnect block in electrical communication with the electroactive polymer actuators of the fluid control devices.

15. The fluid control system of claim 14, wherein the electrical interconnect block comprises a plurality of electrical connection slots configured for receiving an electrical connection tab extending from each of the fluid control devices.

16. The fluid control system of claim 13, wherein at least one of the fluid control devices functions as a valve.

17. The fluid control system of claim 13, wherein at least one of the fluid control devices functions as a regulator.

18. A fuel injector comprising a fluid control device of claim 1.

19. The fuel injector of claim 18, further comprising a pump mechanism comprising an electroactive polymer actuator for controlling fluid flow to a fluid inlet end of the fluid control device.
